(19) United States
(12) Patent Application Publication
(10) Pub. No.: US 2022/0303055 A1
(43) Pub. Date: Sep. 22, 2022

(54) Flexible HARQ Mechanism Adaptation for Sidelink Unicast and Groupcast

(71) Applicant: Apple Inc., Cupertino, CA (US)

(72) Inventors: Zhibin Wu, Los Altos, CA (US); Chunxuan Ye, San Diego, CA (US); Dawei Zhang, Saratoga, CA (US); Fangli Xu, Beijing (CN); Haijing Hu, Beijing (CN); Sarma V. Vangala, Whitehouse Station, NJ (US); Sethuraman Gurumoorthy, San Jose, CA (US); Srirang A. Lovlekar, Cupertino, CA (US); Yuqin Chen, Shenzhen (CN)

(21) Appl. No.: 17/442,065

(22) PCT Filed: May 21, 2020
(86) PCT No.: PCT/CN2020/091574

§ 371 Date: Sep. 22, 2021

(51) Int. Cl. H04L 1/08; H04L 1/18; H04L 5/00; H04W 28/26; H04W 72/02

(52) U.S. Cl. CPC H04L 1/08; H04L 1/1812; H04L 5/0053; H04W 28/26; H04W 72/02

(57) ABSTRACT

Embodiments are presented herein of apparatuses, systems, and methods for a user equipment device (UE) and a network to perform flexible acknowledgement. A UE may determine whether or not to solicit feedback (e.g., HARQ ACK/NACK) for one or more groupcast transmissions. The determination may be based on factors such as a remaining time to perform the transmission and the amount of time needed to perform the transmission with and without allowing time to receive and process feedback.

### TECHNICAL FIELD

The present application relates to wireless devices, and more particularly to apparatuses, systems, and methods for flexible acknowledgements.

### DESCRIPTION OF THE RELATED ART

Wireless communication systems are rapidly growing in usage. Further, wireless communication technology has evolved from voice-only communications to also include the transmission of data, such as Internet and multimedia content.

Mobile electronic devices may take the form of smart phones or tablets that a user typically carries. Wearable devices (also referred to as accessory devices) are a newer form of mobile electronic device, one example being smart watches. Additionally, low-cost low-complexity wireless devices intended for stationary or nomadic deployment are also proliferating as part of the developing “Internet of Things”. In other words, there is an increasingly wide range of desired device complexities, capabilities, traffic patterns, and other characteristics.

One issue in wireless communication includes how or if to mix transmission types in sidelink (e.g., device to device) operations. For example, some transmissions may be associated with blind retransmissions and others may be associated with feedback-based retransmissions (e.g., hybrid automatic repeat request (HARM) operations). Accordingly, improvements in the field may be desired.

### SUMMARY

Embodiments are presented herein of, inter alia, systems, apparatuses, and methods for a wireless device and a network performing flexible acknowledgements.

In some embodiments, (e.g., in new radio (NR) vehicle to everything (V2X) communication systems or other sidelink or device to device communication systems, among various possibilities) a media access control (MAC) layer may be responsible for making resource reservations. The MAC layer (or other layer of a device) may reserve resources for the initial transmission and/or any retransmission(s) of a transport block (TB) or other transmission. The MAC layer (or other layer of a device) may also instruct a lower layer whether or not to request feedback (e.g., according to hybrid automatic repeat request (HARQ)) for the transmission (e.g., initial transmission and/or retransmission). In some embodiments, the initial transmission and retransmissions may share the same HARQ scheme, e.g., whether the HARQ feedback (ACK or NACK) is enabled or blind retransmission is used (e.g., without time in between retransmissions to receive and/or process HARQ feedback). Methods disclosed herein may allow UE to have the flexibility to mix the two methods (e.g., HARQ feedback and blind retransmission) together. A UE may flexibly adapt HARQ schemes to meet quality of service or other requirements of the sidelink communication.

The techniques described herein may be implemented in and/or used with a number of different types of devices, including but not limited to cellular phones, tablet computers, accessory and/or wearable computing devices, portable media players, vehicles, access points and other wireless local area network equipment, cellular base stations and other cellular network infrastructure equipment, servers, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the disclosed embodiments can be obtained when the following detailed description is considered in conjunction with the following drawings, in which:

FIG. 1 illustrates an example wireless communication system, according to some embodiments;

FIG. 2 illustrates an example wireless communication system in which two user equipment devices (UEs) can perform communication, according to some embodiments;

FIG. 3 illustrates an example block diagram of a UE, according to some embodiments;

FIG. 4 illustrates an example block diagram of a base station (BS), according to some embodiments;

FIG. 5 illustrates an example block diagram of cellular communication circuitry, according to some embodiments;

FIGS. 6 and 7 illustrate examples of a 5G NR base station (gNB), according to some embodiments; and

FIGS. 8 and 9 illustrate aspects of flexible acknowledgements, according to some embodiments.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE EMBODIMENTS

### Terms

The following is a glossary of terms used in the present application:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™ Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, vehicle, automobile, unmanned aerial vehicles (e.g., drones) and unmanned aerial controllers, etc. In general, the term “UE” or “UE device” can be broadly defined to encompass any electronic, computing, and/or telecommunications device (or combination of devices) which is easily transported by a user and capable of wireless communication.

Wireless Device—any of various types of computer system devices which performs wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device. A communication device may be referred to as a station or STA.

Base Station or Access Point (AP)—The term “Base Station” has the full breadth of its ordinary meaning, and at least includes a wireless communication station installed at a fixed location and used to communicate as part of a wireless telephone system or radio system. The term “access point” is used similarly.

Link Budget Limited—includes the full breadth of its ordinary meaning, and at least includes a characteristic of a wireless device (e.g., a UE) which exhibits limited communication capabilities, or limited power, relative to a device that is not link budget limited, or relative to devices for which a radio access technology (RAT) standard has been developed. A wireless device that is link budget limited may experience relatively limited reception and/or transmission capabilities, which may be due to one or more factors such as device design, device size, battery size, antenna size or design, transmit power, receive power, current transmission medium conditions, and/or other factors. Such devices may be referred to herein as “link budget limited” (or “link budget constrained”) devices. A device may be inherently link budget limited due to its size, battery power, and/or transmit/receive power. For example, a smart watch that is communicating over LTE or LTE-A with a base station may be inherently link budget limited due to its reduced transmit/receive power and/or reduced antenna. Wearable devices, such as smart watches, are generally link budget limited devices. Alternatively, a device may not be inherently link budget limited, e.g., may have sufficient size, battery power, and/or transmit/receive power for normal communications over LTE or LTE-A, but may be temporarily link budget limited due to current communication conditions, e.g., a smart phone being at the edge of a cell, etc. It is noted that the term “link budget limited” includes or encompasses power limitations, and thus a power limited device may be considered a link budget limited device.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network. Wi-Fi or WLAN may refer to technology based on IEEE 802.11 wireless standards such as 802.11a, 802.11.b, 802.11g, 802.11n, 802.11-2012, 802.11ac, 802.11ax, 802.11he, 802.11ad, 802.11.ax, 802.11ay, 802.11az, and/or other IEEE 802.11 standards.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

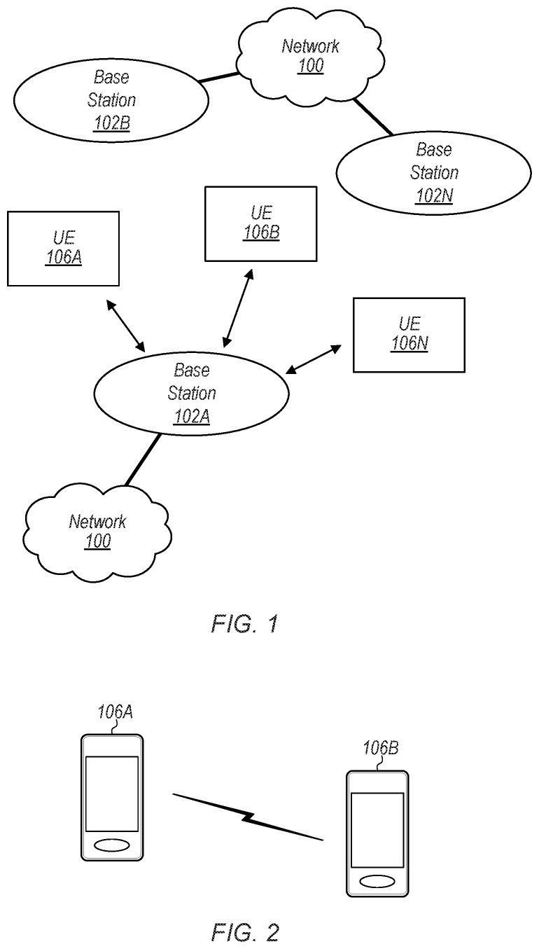

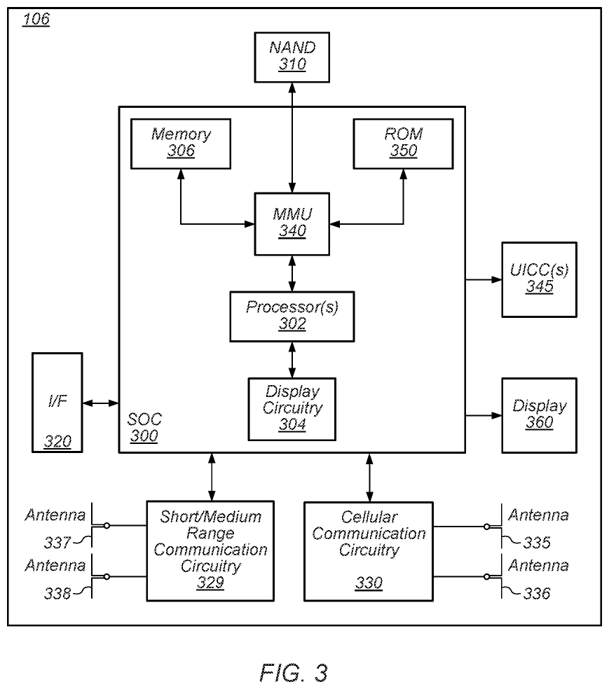

### FIGS. 1 and 2—Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102 which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102 may be a base transceiver station (BTS) or cell site (a “cellular base station”), and may include hardware that enables wireless communication with the UEs 106A through 106N.

The communication area (or coverage area) of the base station may be referred to as a “cell.” The base station 102 and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102 is implemented in the context of LTE, it may alternately be referred to as an ‘eNodeB’ or ‘eNB’. Note that if the base station 102 is implemented in the context of 5G NR, it may alternately be referred to as ‘gNodeB’ or ‘gNB’.

As shown, the base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication between the user devices and/or between the user devices and the network 100. In particular, the cellular base station 102 may provide UEs 106 with various telecommunication capabilities, such as voice, SMS and/or data services.

Base station 102 and other similar base stations operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102 may act as a “serving cell” for UEs 106A-N as illustrated in FIG. 1, each UE 106 may also be capable of receiving signals from (and possibly within communication range of) one or more other cells (which might be provided by other base stations 102B-N), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. Other configurations are also possible.

In some embodiments, base station 102 may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

FIG. 2 example UE devices 106A and 106B in communication with each other, according to some embodiments. The communication may include sidelink communication and may be facilitated by one or more BS 102, according to some embodiments. The UEs 106 may communicate with each other directly, e.g., potentially using time and/or frequency resources scheduled by the BS. The UEs 106 may each be a device with cellular communication capability such as a mobile phone, a hand-held device, a computer or a tablet, a vehicle, or virtually any type of wireless device.

The UEs 106 may include a processor that is configured to execute program instructions stored in memory. The UE 106s may perform any of the method embodiments described herein by executing such stored instructions. Alternatively, or in addition, one or more of the UE 106s may include a programmable hardware element such as an FPGA (field-programmable gate array) that is configured to perform any of the method embodiments described herein, or any portion of any of the method embodiments described herein.

The UEs 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for multiple-input, multiple-output or “MIMO”) for performing wireless communications. In general, a radio may include any combination of a baseband processor, analog RF signal processing circuitry (e.g., including filters, mixers, traces, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UEs 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams).

In some embodiments, the UEs 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

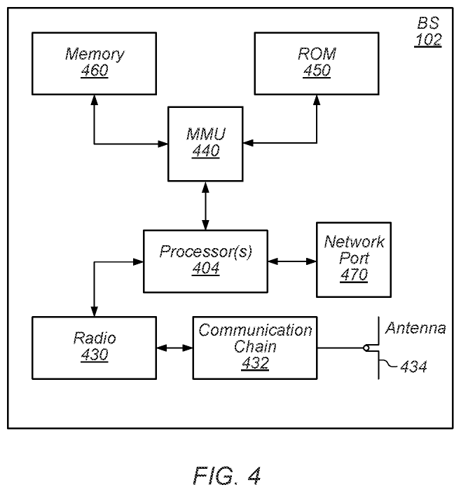

### FIG. 3—Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains for multiple RATs (e.g., a first receive chain for LTE and a second receive chain for 5G NR). Such receive chains may include and/or be communicatively coupled (e.g., directly or indirectly) to dedicated processors and/or radios. In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may be configured to transmit a request to attach to a first network node operating according to the first RAT and transmit an indication that the wireless device is capable of maintaining substantially concurrent connections with the first network node and a second network node that operates according to the second RAT. The wireless device may also be configured transmit a request to attach to the second network node. The request may include an indication that the wireless device is capable of maintaining substantially concurrent connections with the first and second network nodes. Further, the wireless device may be configured to receive an indication that dual connectivity (DC) with the first and second network nodes has been established.

As described herein, the communication device 106 may include hardware and software components for implementing features for using multiplexing to perform transmissions according to multiple radio access technologies in the same frequency carrier (e.g., and/or multiple frequency carriers), as well as the various other techniques described herein. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements and/or processors. In other words, one or more processing elements/processors may be included in cellular communication circuitry 330 and, similarly, one or more processing elements/processors may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 330. Similarly, the short range wireless communication circuitry 329 may include one or more ICs that are configured to perform the functions of short range wireless communication circuitry 329. In addition, each integrated circuit may include circuitry (e.g., first circuitry, second circuitry, etc.) configured to perform the functions of short range wireless communication circuitry 329.

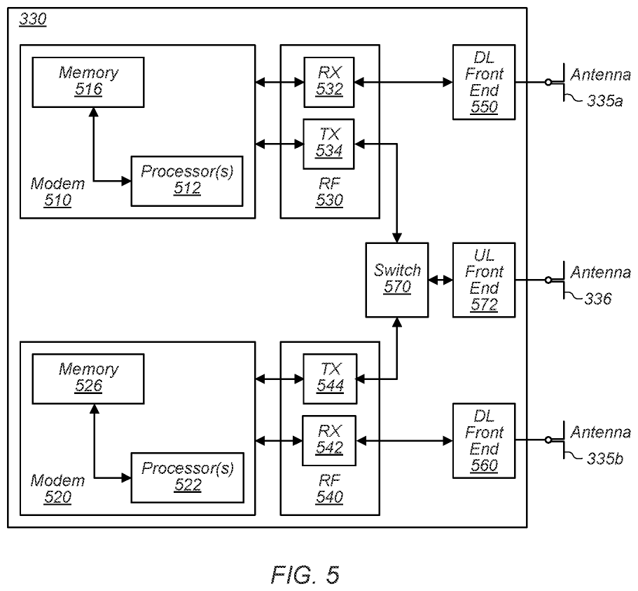

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNB s.

The base station 102 may include at least one antenna 434, and possibly multiple antennas. The radio 430 and at least one antenna 434 may be configured to operate as a wireless transceiver and may be further configured to communicate with UE devices 106. The antenna 434 may communicate with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

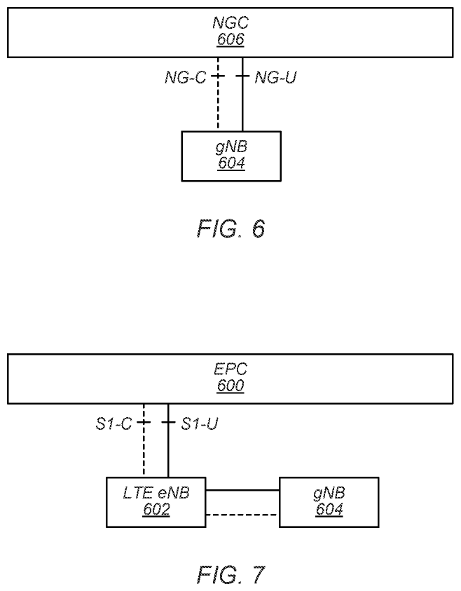

### FIG. 5—Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, are also possible. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown (in FIG. 3). In some embodiments, cellular communication circuitry 330 may include dedicated receive chains for multiple RATs (e.g., a first receive chain for LTE and a second receive chain for 5G NR). Such receive chains may include and/or be communicatively coupled (e.g., directly or indirectly) to dedicated processors and/or radios. For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 330 may be configured to transmit, via the first modem while the switch is in the first state, a request to attach to a first network node operating according to the first RAT and transmit, via the first modem while the switch is in a first state, an indication that the wireless device is capable of maintaining substantially concurrent connections with the first network node and a second network node that operates according to the second RAT. The wireless device may also be configured transmit, via the second radio while the switch is in a second state, a request to attach to the second network node. The request may include an indication that the wireless device is capable of maintaining substantially concurrent connections with the first and second network nodes. Further, the wireless device may be configured to receive, via the first radio, an indication that dual connectivity with the first and second network nodes has been established.

As described herein, the modem 510 may include hardware and software components for implementing features for using multiplexing to perform transmissions according to multiple radio access technologies in the same frequency carrier, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In some embodiments, processor(s) 512, 522, etc. may be configured to implement or support implementation of part or all of the methods described herein, e.g., by executing program instructions stored on a memory medium (e.g., a non-transitory computer-readable memory medium). Alternatively, the processor(s) 512, 522, etc. may be configured as a programmable hardware element, such as an FPGA, or as an ASIC, or a combination thereof. In addition, as described herein, processor(s) 512, 522, etc. may include one or more processing elements. Thus, processor(s) 512, 522, etc. may include one or more integrated circuits (ICs) that are configured to perform the functions of processor(s) 512, 522, etc. In addition, each integrated circuit may include circuitry (e.g., first circuitry, second circuitry, etc.) configured to perform the functions of processor(s) 512, 522, etc.

As described herein, the modem 520 may include hardware and software components for implementing features for using multiplexing to perform transmissions according to multiple radio access technologies in the same frequency carrier, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

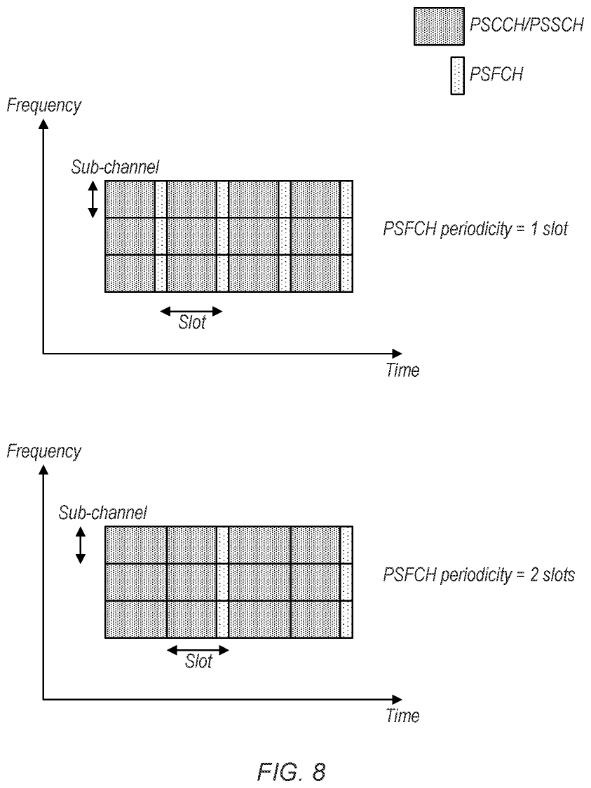

### FIGS. 6-7—5G NR Architecture

In some implementations, fifth generation (5G) wireless communication will initially be deployed concurrently with other wireless communication standards (e.g., LTE). For example, whereas FIG. 6 illustrates a possible standalone (SA) implementation of a next generation core (NGC) network 606 and 5G NR base station (e.g., gNB 604), dual connectivity between LTE and 5G new radio (5G NR or NR), such as in accordance with the exemplary non-standalone (NSA) architecture illustrated in FIG. 7, has been specified as part of the initial deployment of NR. Thus, as illustrated in FIG. 7, evolved packet core (EPC) network 600 may continue to communicate with current LTE base stations (e.g., eNB 602). In addition, eNB 602 may be in communication with a 5G NR base station (e.g., gNB 604) and may pass data between the EPC network 600 and gNB 604. In some instances, the gNB 604 may also have at least a user plane reference point with EPC network 600. Thus, EPC network 600 may be used (or reused) and gNB 604 may serve as extra capacity for UEs, e.g., for providing increased downlink throughput to UEs. In other words, LTE may be used for control plane signaling and NR may be used for user plane signaling. Thus, LTE may be used to establish connections to the network and NR may be used for data services. As will be appreciated, numerous other non-standalone architecture variants are possible.

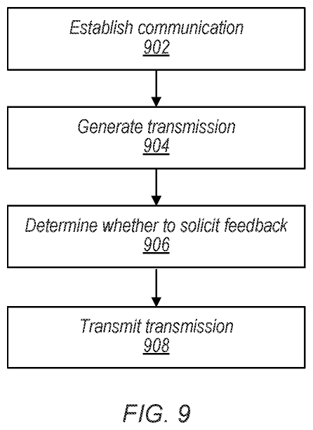

### FIGS. 8-9—Flexible Acknowledgement

Hybrid automatic repeat request (HARQ) feedback may be used to improve reliability for various types of wireless communication, such as sidelink (SL) communication. HARQ feedback may include positive acknowledgements (ACK) and/or negative acknowledgements (NACK), e.g., to indicate that a receiver has or has not successfully received a communication. Various schemes for HARQ in SL (e.g., or other types of) communication may be used, e.g., in groupcast and/or unicast operations. Groupcast may be a special case of multicast operations. Multicast may include multi-hop operations (e.g., multicast may refer to communication from end-to-end perspective which may go across multiple network segments). Groupcast may refer to single-hop operation (e.g., direct device to device communication, e.g., without intermediate devices or network segments). Distance-limited or otherwise location-based groups may be an example of groupcast operations. In some embodiments, in unicast operation, individual UEs may provide ACK or NACK feedback for communications. In some embodiments, a group of UEs (e.g., for groupcast) may be formed based on characteristics such as UE type (e.g., vehicle, smart phone, etc.), location/region, application executing on the UE, etc. For V2X communication, the group involved in a groupcast may be a group of vehicles moving together (e.g., vehicle platooning), or a group of road participants which is relevant to a common purpose. For example, cars, pedestrians, bikers, and traffic-lights may coordinate with each other in an intersection. In groupcast, HARQ operations may be performed in any of various manners. HARQ feedback may also be used in SL unicast communication, where only two UEs are involved.

A first example of groupcast feedback may be a location-based (e.g., distance-based) NACK-only scheme. Any group member in a particular geographic region (e.g., within a certain radius of a transmitting (TX) UE, within a defined zone, etc.) may provide NACK feedback if it fails to receive or decode a communication. Such a scheme may be applicable to vehicles, among various possibilities. For example, a group may be based on a geographic region, e.g., a vehicular group may include all vehicular UEs within a specified geographic region, which may be defined by size or range of communication of the vehicular UEs, among other possibilities. For example, a transmitted communication may include an indication of the region, such as geographic coordinates of the TX UE, radius, a zone identifier, boundaries of the region, etc. In this example, the geographic region may move over time, although static regions are also envisioned.

A second example of groupcast feedback may be a group-based NACK-only scheme without location constraint. Any group member (e.g., at any location) that fails to receive or decode a communication may provide NACK feedback. An example of such a group may include a vehicle platoon (e.g., a group of trucks and/or cars, e.g., travelling in the same direction on a roadway). A groupcast message sent by the leading vehicle (or any vehicle near the beginning of the platoon) may be intended to be received by all the following vehicles belonging to this platoon. There may not be a distance-based constraint in regards of the size of the platoon or the distance the message transmission is to reach (e.g., the distance from the transmitting vehicle to a receiving vehicle in the platoon).

A third example of groupcast feedback may be an individual ACK/NACK scheme. Feedback (e.g., ACK or NACK) may be transmitted from and to individual group members. Note that this scheme may also be used for SL unicast case. In unicast, the single receiving UE may send either ACK or NACK to the transmitting UE.

For a TX UE which supports SL unicast and groupcast, with HARQ feedback enabled, the UE may retransmit a transmission (e.g., a media access control (MAC) protocol data unit (PDU), frame, packet, transport block (TB), SL resource block (SLRB), symbol, aggregated MAC PDU, and/or other communication) only if feedback indicates the transmission failed (e.g., if a NACK is received, or possibly if an (e.g., expected) ACK from at least one group member is not received). If HARQ feedback is not enabled, the UE may perform blind retransmission, e.g., the UE may retransmit the transmission anyway (e.g., whether or not it was received). For NR SL communication, a SL TB may consist of a source address, a destination address, and a MAC PDU. The MAC PDU may multiplex data from one or multiple SL logical channels and may also include an optional SL MAC CE (Control element). From the physical layer perspective, the retransmission of a TB may serve to retransmit the Layer 2 MAC data, e.g., a MAC PDU. Thus, in terms of HARQ operation, a TB and a PDU may be similar.

In some embodiments, SL communications may operate according to either of two modes, although more modes may be implemented in other embodiments. In mode 1, a base station (e.g., BS 102) may schedule (e.g., individual) SL transmissions. For example, a UE may transmit a scheduling request and the BS may provide one or more SL grants to allocate and/or schedule (e.g., time and/or frequency) resources for the requested transmission(s).

In mode 2, a BS may provide resource pools for SL transmissions, but may not schedule particular SL transmissions. For example, the BS may provide a pool of resources and UEs may use a contention-based approach (e.g., listen-before-talk, reservations, etc.) to acquire resources for a transmission. A resource pool may be subdivided for various types of transmissions. FIG. 8 illustrates aspects of an SL resource pool, according to some embodiments. For example, as shown in FIG. 8, a first portion of a resource pool may be allocated for SL control and/or data channels (e.g., physical SL control channel (PSCCH) and/or physical SL shared channel (PSSCH)) and a second portion of the resource pool may be allocated for SL feedback (e.g., HARQ ACK/NACK), e.g., a physical SL feedback channel (PSFCH). For example, PSFCH can be allocated resources at various times, e.g., once every 1, 2, 3, or 4 (or more) slots in a SL resource pool, among various possibilities. According to various embodiments, PSFCH may occupy all or any portion(s) of bandwidth of the SL resource pool, e.g., at a first time PSFCH may be allocated to all subcarriers and at a second time PSFCH may be allocated to a subset of subcarriers.

In some embodiments, SL control information (SCI) may have two parts. The first part (e.g., 1^{st} stage) may and may include information broadcasted to every UE (e.g., in a geographic region). In other words, the 1^{st} stage may be destination-agnostic. The UEs receiving the 1^{st} stage SCI may take this information into account. The second part (e.g., 2nd stage) of SCI may be a destination-specific portion, e.g., it may be addressed to one or more UEs. Thus, UEs which match the destination address may process the second part. In some embodiments, two 2nd-stage SCI formats may be available, e.g., SCI formats A and B. SCI format A may be used for location-based group-cast. Location-based parameters such as “zone ID” and/or “range” may be included. Receiving (RX) UEs that are outside of the zone or range may determine that they are not intended recipients and may determine not to provide feedback (e.g., ACK/NACK). The transmission may also include one or more indications of which UEs a transmission is directed to, e.g., a group ID, UE ID, etc.

SCI format B may be shared among groupcast, unicast, and broadcast communication. In some embodiments, SCI format B may not include location-based parameters, but may include indications of which UEs a transmission is directed to, e.g., a group ID, UE ID, etc.

In some embodiments, an SL grant may separate (e.g., may not mix) the data from logical channels (LCHs) with “Feedback (FB) disabled” and LCHs with “FB enabled”. This may be done by a LCP (Logical Channel Prioritization) procedure to create a transmission (e.g., TB, MAC PDU, etc.) for SL transmission. However, the (re)transmission of such a transmission may be flexible (e.g., according to techniques disclosed herein) even though the LCP procedure may (e.g., largely or potentially entirely) separate different LCHs into different transmissions. LCHs with “FB disabled” which multiplexed in a particular TB may (e.g., by default) use blind retransmissions. In other words, no PSFCH resources may be provided for “FB disabled” LCHs. In some embodiments, LCHs with “FB enabled” (e.g., which may be multiplexed in a particular TB, MAC PDU, or other transmission) may switch between using PSFCH and not using PSFCH, according to some embodiments. In other words, as disclosed herein, even when PSFCH resources are configured for a transmission (e.g., a TB is mapped based LCP for transmission in a SL resource pool including PSFCH), the UE may determine whether to trigger receiving UE(s) to use PSFCH or not dynamically. In other embodiments, LCHs with “FB enabled” may not switch, e.g., they may (e.g., consistently) use PSFCH.

Various UE retransmission behaviors may be possible. A UE may be configured to retransmit a transmission (e.g., a MAC PDU) up to 31 times, according to some embodiments. For example, the parameter sl-MaxTxTransNumPSSCH-r16 may be configured (e.g., in radio resource control (RRC)) to be between 1-32 (e.g., including an original transmission and retry(s), although other ranges are also envisioned). The actual (re)transmissions may be bound by a packet delay budget (PDB) or other time available for the transmission. The time available may be related to an amount of time that a transmission may be useful to a recipient. For example, data related to motion of a vehicle may be updated periodically, and thus a transmission may only be useful until the time of the update. The time available may be a period (e.g., a number of ms, etc.) from when a transmission is first generated (e.g., and received by a lower level of a device for transmission) to a time when further (re)transmissions of the transmission will no longer be useful.

One problem in wireless communication system design may include whether to support mixing blind and feedback-based HARQ retransmissions of a transmission in SL HARQ operations. Various embodiments discussed herein may address the following issues, among various possibilities. Embodiments may include techniques for a UE (re)transmitting a transmission containing logical channels with “Feedback enabled” to indicate whether its transmission requests PSFCH feedback. Further, embodiments may include techniques for a UE to reserve retransmission resource for the next attempt in a “blind” fashion, e.g., by assuming no PSFCH feedback is required or expected.

In some cases, feedback for an SL transmission (e.g., associated with an LCH for which feedback is enabled) may not be relevant (e.g., helpful). For example, if the SL transmission is the last available transmission before a maximum retry limit (e.g., configured by RRC) is reached, no further retransmission of the SL transmission may be performed. Thus, feedback may not be relevant because feedback would not change a retransmission decision. Similarly, if the SL transmission is the last transmission before a packet delay budget (PDB) associated with the transmission is reached, no further retransmission may be performed and feedback may not be relevant. For example, the transmission may be time-sensitive, such that a retransmission would not serve any useful purpose (e.g., because the retransmission would be outside of the time window where the transmission was relevant). Accordingly, allowing a UE to indicate that (e.g., PSFCH transmission) feedback is not required for some (e.g., feedback enabled) SL transmissions may offer some benefits. Such benefits may include saving PSFCH resources (e.g., which could be used for other purposes) and/or reducing PSFCH collisions.

Quality of service (QoS) may be considered in determining whether to enable HARQ feedback for various transmissions. Transmissions may be mapped to LCHs based on QoS requirements and/or other factors, according to some embodiments. For example, LCH configurations for each QoS flow mapped to a sidelink resource block (SLRB) may be based on reliability requirements (e.g., a block, bit, or packet error rate, etc.) of QoS to determine whether HARQ-feedback is used.

In some embodiments, an LCH with HARQ feedback enabled may be associated with higher reliability is expected in QoS. An LCH with HARQ feedback disabled may be associated with lower reliability levels.

Different feedback approaches may be associated with different scheduling techniques. For example, different timeline considerations may be applicable in resource selection depending on whether HARQ-feedback is enabled. For example, a UE may consider transmission time requirements (e.g., packet delay budget (PDB)) associated with latency standards or other QoS standards, e.g., regardless of whether HARQ feedback is enabled. If HARQ feedback is enabled, the UE may further consider allowing time between transmissions for HARQ feedback.

In some embodiments, if HARQ-feedback is disabled, the UE may select TX resources to satisfy transmission timing requirements of the transmission(s).

In some embodiments, if HARQ-feedback is enabled, a UE may ensure a minimum time gap between any two selected resources for transmissions, e.g., in addition to transmission time requirements. This time gap may allow for HARQ feedback for a transmission on the first of these selected resources. This time gap may be represented as Z, where: Z=a +b. In this equation, ‘a’ may be a time gap between the end of the last symbol of the (e.g., PSSCH) transmission of the first resource and the start of the first symbol of the corresponding feedback (e.g., PSFCH) reception. ‘a’ may be determined by resource pool configuration and higher layer parameters (e.g., MinTimeGapPSFCH, periodPSFCHresource, and/or other parameters). Further, ‘b’ may be a time for PSFCH reception and processing plus (e.g., SL) retransmission preparation, including time for multiplexing of physical channels and any switching time (e.g., TX-RX and/or RX-TX). Thus, ‘b’ may be UE specific and may be determined by UE implementation.

As noted above, PSFCH may be as sparse as once every 1, 2, or 4 slots in a SL resource pool (e.g., periodPSFCHresource may be 1, 2, or 4 slots, etc.), according to some embodiments. A minimum time between a transmission and feedback may be set by a higher layer parameter (e.g., MinTimeGapPSFCH). In some embodiments, this minimum time may be 2 or 3 slots, among various possibilities. The UE may also use additional time to process feedback (e.g., PSFCH) and do an Rx/Tx switch.

Thus, the minimum time gap between a transmission and a retransmission may depend on whether feedback is enabled. For example, if feedback is enabled, a minimum time gap may be multiple slots. If feedback is not enabled, no minimum time gap may be required (e.g., minimum time gap may be zero).

This minimum time gap may relate to how many retransmissions of a transmission may be scheduled within a transmission time requirement. For example, a fixed PDB value or other transmission time requirement may only accommodate two (e.g., feedback-based) retransmissions with feedback enabled, but may accommodate four (e.g., blind) retransmissions with feedback disabled, among various possibilities. For example, with feedback disabled, the retransmissions may be transmitted without a delay between them (e.g., they may be consecutively transmitted without time for receiving and processing feedback). Thus, by allowing reservation for blind-retransmission, a UE may (re)transmit more times and achieve higher reliability than HARQ feedback-enabled alternative. Blind retransmission may be transmitted without time for receiving and/or processing feedback), according to some embodiments. Due to the time gap requirements for HARQ feedback retransmission described above, the blind re-transmissions may be flexibly used if the required reliability is very high and/or the latency (e.g., transmission time requirement or remaining packet delay budget) is not large enough to allow for feedback-based retransmissions. Thus, some blind transmissions may be transmitted based on previously received negative feedback. Similarly, feedback may be solicited (e.g., and received and processed) for some transmissions which could (e.g., are originally supposed to) use blind transmissions, if PSFCH resources are available. In some embodiments, a UE may adapt resource reservations and adaptively select whether/how to solicit feedback, e.g., based on timeline requirements and/or other considerations, as further illustrated in FIG. 9.

It will be appreciated that the above examples of transmission timing have been presented in terms of slots, but any units may be used as desired (e.g., symbols, subframes, etc.).

FIG. 9 illustrates exemplary techniques for performing flexible acknowledgement, according to some embodiments. Aspects of the method of FIG. 9 may be implemented by a wireless device, such as the UE 106, in communication with a network 100 and one or more base stations 102 as illustrated in and described with respect to the Figures, or more generally in conjunction with any of the computer systems or devices shown in the Figures, among other circuitry, systems, devices, elements, or components shown in the Figures, among other devices, as desired. For example, one or more processors (or processing elements) (e.g., processor(s) 302, 404, 512, 522, baseband processor(s), processor(s) associated with communication circuitry 329 or 330, processors associated with various core network elements, etc., among various possibilities) may cause a UE, network element, and/or BS to perform some or all of the illustrated method elements. Note that while at least some elements of the method are described in a manner relating to the use of communication techniques and/or features associated with 3GPP specification documents, such description is not intended to be limiting to the disclosure, and aspects of the method may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method may operate as follows.

A UE 106 may establish communication with one or more other UEs 106 and/or a BS 102 (902), according to some embodiments. The communication may include uplink, downlink, and/or sidelink (SL) communication. For example, the UE 106 may send and/or receive data and/or control information from the one or more other UEs and/or BS. The communication may include the UE transmitting and/or receiving unicast (e.g., one device to one device), groupcast (e.g., one device to a specified group of devices), and/or broadcast (e.g., one device to all devices in range) communication. The UE 106 may join or be part of one or more groups for (e.g., SL) groupcast communications.

In some embodiments, the UE 106 may be a vehicle and/or the communication may be vehicle to everything (V2X) communication, among various possibilities. For example, the UE 106 may be one of a group of vehicles in a region (e.g., a road, intersection, etc.) exchanging information about their movement (e.g., acceleration, braking, turning, etc.). Such communication may be or include ultra-reliable low latency communication (URLLC) communication and/or may be associated with standards for latency, transmission time, and/or reliability. However, the UE may not be a vehicle and/or the communication may not be a V2X communication, according to some embodiments. For example, embodiments may include other types of UEs performing other types of communication.

In some embodiments, the UE 106 may receive control information (e.g., from a BS 102) to configure a flexible feedback scheme. Such configuration may be semi-static (e.g., indicated in RRC) and/or dynamic (e.g., indicated in SL control information (SCI)). The control information may specify whether or not a flexible feedback scheme is enabled, a maximum number (e.g., N) of blind retransmissions that may be performed for a transmission, under what conditions a transmission may (or may not) be eligible for a flexible feedback scheme, etc. In the case of semi-static configuration, the configuration may be provided in one or more of the following ways, among various possibilities:

per-UE (e.g., via SL-PSSCH-TxConfig and/or similar parameters),

per SL resource pool (e.g., for a pool with PSFCH resources, flexible feedback may be selectively enabled (with particular configuration) or disabled) (note that, for a pool without PSFCH resources, blind retransmission may be used, e.g., HARQ feedback may be disabled), and/or

per transmission characteristic (e.g., QoS flow configuration, LCH, SLRB, etc.) (e.g., for some or any flow/LCH/SLRB with feedback enabled, flexible feedback may be selectively enabled (with particular configuration) or disabled).

To account for dynamic channel conditions, the network and/or BS may also (or alternatively) provide parameters indicating that flexible feedback is enabled under certain conditions or that flexible feedback configuration may vary depending on conditions. Such conditions may include congestion as measured by channel occupancy ratio (CR) which takes into account the UE's own usage and/or channel busy ratio (CBR), and/or other measures of channel conditions. Any combination of dynamic and/or static configuration may be used. For example, a configured maximum number of blind transmissions may vary based on (e.g., as a function of) congestion and/or for different resource pools, etc. In other words, the network may provide configuration information including different maximum numbers of blind retransmissions based on congestion levels (e.g., CR, CBR) for a pool, and the UE may determine a current or recent congestion level to determine the currently applicable maximum number of blind retransmissions for the pool.

In some embodiments, in a flexible feedback scheme, the UE may be configured to potentially make a reservation for a number of reservations for retransmissions “blindly”, e.g., without waiting for HARQ feedback. The number may be bounded by a threshold N, which may be configured as control information. N may be 0, according to some embodiments. N may be less than a retransmission parameter (e.g., configured by a higher layer, e.g., RRC or dynamically, e.g., via SCI) such as sl-MaxTxTransNumPSSCH-r16-1.

In some embodiments, blind retransmission in a flexible feedback scheme may be “boolean”, e.g., either allowed or not as indicated in the control information. Whether blind retransmission is allowed may be configured by a higher layer, e.g., RRC or dynamically, e.g., via SCI. In some embodiments, whether blind retransmission is allowed may be configured per-UE, per-pool, per-LCH, per-SLRB, and/or per-QoS flow, etc., as described above.

In some embodiments, if blind retransmission in a flexible feedback scheme is allowed, it may be default behavior, e.g., and may be used in case a remaining transmission time may not allow for a desired number of (e.g., feedback-based) retransmissions, e.g., in order to meet a reliability requirement.

In some embodiments, a BS 102 may provide transmission specific control information. For example, a transmitting (TX) UE 106 may employ a network-scheduled mode and request resource allocation from a BS. Thus, a BS may directly control how the UE conducts a SL HARQ process for a certain transmission (e.g., MAC PDU, TB, etc.). The UE 106 may receive DCI (downlink control information) in PDCCH (Physical Downlink Control Channel) from its serving base station (e.g., from a BS 102) to allocate a dynamic grant which provides resources for one or multiple SL transmissions (e.g., the transmission, e.g., the MAC PDU, TB, etc.). The BS 102 may indicate whether blind retransmission is allowed or not, (e.g., an explicit indicator in DCI for a particular transmission). Alternatively, without using explicit indication, BS 102 can indicate implicitly whether blind transmission is allowed. For example, by having two consecutive SL resources which are tightly spaced in time domain (e.g., for a first and second (re)transmission of the particular transmission), the BS may indicate that blind transmission may be used. In other words, the BS may implicitly indicate that blind transmission may be used by scheduling resources without sufficient time for HARQ feedback-based decision of whether or not to perform a retransmission. In such a case, the UE 106 (e.g., by following BS 102 instructions in DCI or an implicit indication) may only conduct blind retransmission in the 2^{nd} resource and may not solicit HARQ feedback corresponding to the transmission scheduled in the 1^{st} resource. As an alternative means of implicit indication, the BS may use uplink grants (e.g., or lack thereof) to indicate whether blind transmission may be used. For example, if PUCCH resource is not provided in dynamic grant allocation for a HARQ process, then the TX UE 106 may not have the uplink resource to send HARQ feedback to solicit new SL grants for retransmission. Then, UE 106 may rely on an SL BSR (Buffer Status report) to BS 102 and use SL grants allocated by BS 102 for blind retransmission(s). As an example, if no PUCCH grant is provided, the UE may lack resources to share SL feedback with the BS. Therefore, the UE may not reserve resources for a feedback-based transmission in response to any negative feedback. Instead, the UE may use the SL BSR to indicate to the BS that it still has data to send (e.g., a number of retransmissions, the number of bits for the retransmissions, etc.). In response to the BSR, the BS may provide a SL grant to the UE. The UE may use the resources of the SL grant to perform the retransmissions blindly.

In some embodiments, the control or configuration information may indicate how or if the UE is allowed to mix blind retransmission(s) for a TB (transport block) marked for HARQ-feedback-based retransmission. For example, the SCI may indicate whether some transmissions of a flow, LCH, SLRB, etc. that enables feedback may be transmitted as blind retransmissions (e.g., not in response to negative feedback of an immediately preceding transmission). For example, the SCI may indicate whether flexible feedback is enabled. For example, the SCI may indicate whether UE may do HARQ-enabled retransmission for a TB (transport block) marked for blind retransmission

In some embodiments, the UE 106 may provide information to the BS 102 (and/or network 100 and/or other UEs 106) relating to its capabilities with regard to a flexible feedback scheme. For example, the UE may indicate whether it supports such a scheme, the UE's time for handling certain messages (e.g., to receive and process feedback) and/or transitioning between RX and TX, etc.

The UE 106 may generate a transmission (904), according to some embodiments. For example, the transmission may be an SL groupcast or unicast transmission, among various possibilities. The transmission may be a first transmission (e.g., a first time the UE has transmitted the particular transmission) or may be a retransmission (e.g., of a previously transmitted transmission). The transmission may be associated with one or more quality of service (QoS) parameters, e.g., related to latency, transmission time, reliability, etc. For example, the transmission may be a URLLC type communication.

The UE 106 may determine whether to solicit feedback for the transmission (906), according to some embodiments. Further, the UE may determine a (e.g., remaining) number of blind retransmissions, according to some embodiments. The UE may consider various factors in determining whether to solicit feedback and/or how many blind retransmissions to perform. For example, the UE may consider factors related to the transmission (e.g., mapping of the transmission to a logical channel, reliability, number of potential retransmissions remaining, remaining time for retransmissions, other QoS parameters, etc.), factors related to wireless medium conditions (e.g., congestion, signal strength, etc.), and/or other factors.

In some embodiments, reliability (e.g., based on QoS of a transmission) may be considered in grouping transmissions to logical channels. For example, reliability may be considered in QoS flow to SLRB mapping. In other words, some QoS flows and/or some transmissions may be associated with a flexible feedback scheme and other flows/transmissions may be associated with a non-flexible feedback scheme.

In some embodiments, to determine whether a transmission is eligible for a flexible feedback scheme, the UE may consider static and/or dynamic configuration information (as described above regarding 902) in relation to characteristics of the transmission. For example, the UE may consider an LCH/SLRB or QoS flow, etc. For example, for QoS flows which are configured to allow flexible HARQ adaptation (e.g., to maximize the reliability of SL transport), transmissions may be mapped to the SLRB(s) which are “HARQ FB enabled”. Thus, transmissions associated with such flows may be eligible for flexible feedback. Such eligibility may be static (e.g., based on the LCH, SLRB, or flow) or dynamic, e.g., in view of current conditions (e.g., congestion level). The UE may perform one or more measurements and/or receive information about current conditions from another device (e.g., BS 102, other UE 106, etc.) to determine current conditions.

For example, in a non-flexible feedback scheme, some flows/transmissions may be designated for requesting feedback while other flows/transmissions may be designated for not requesting feedback (and possibly with a particular number or level of blind retransmissions). For example, if a transmission is mapped to an LCH or SLRB (or otherwise associated) with feedback (e.g., non-flexibly) enabled, a UE may trigger retransmissions based on feedback (e.g., PSFCH), according to some embodiments. Similarly, if a transmission is mapped to an LCH or SLRB (or otherwise associated) with feedback (e.g., non-flexibly) disabled, a UE may determine a number of blind retransmissions (e.g., potentially zero, or any number larger than zero) and may perform the determined number of blind retransmissions without feedback (e.g., PSFCH). In the case of a transmission/flow associated with a flexible feedback scheme, the UE may make a determination for each transmission of whether or not to solicit feedback for the transmission, e.g., as further described below.

In some embodiments, for a flexible feedback scheme, in determining whether to solicit feedback for the transmission, the UE may consider timing information associated with retransmissions (e.g., how much time is required to perform retransmission with and/or without feedback) in relation to any restrictions on how many retransmissions may be performed and/or any transmission time requirement (e.g., PDB, latency, etc.) of a transmission. For example, the UE may determine how many retransmissions may be performed with feedback enabled prior to transmitting a target number of blind retransmissions within a transmission time requirement for the transmission. Similarly, the UE may consider whether or not any time gaps in resources provided (e.g., in the control information) allow time for the UE to receive and process feedback. Similarly, the UE may consider whether or not any resources provided (e.g., in the control information) allow for the UE to receive and process feedback and then solicit further sidelink resources for further (e.g., feedback-based) retransmission.

As one possibility, the UE may determine a threshold number of retransmissions. The threshold number of retransmissions may be a (e.g., minimum) number of retransmissions expected to comply with a reliability target (e.g., an error rate at a receiver of another UE, e.g., in view of channel conditions, code rate, etc.). The threshold number of retransmissions may be configured by a network (e.g., for a particular QoS, etc.) and indicated by SCI or other configuration information.

The UE may determine an amount of time to perform the threshold number of retransmissions with feedback enabled, and may compare this amount of time to any transmission time requirement. The amount of time to perform the number of retransmissions to meet the reliability target may be determined in consideration of the configuration information, such as feedback scheduling information, e.g., how often and/or when PSFCH may be scheduled. Further, the UE may consider the minimum time gap between transmissions, e.g., as discussed above. If the transmission time requirement(s) provide enough time for the number of transmissions (e.g., including time to receive and process feedback) expected to satisfy the reliability target, the UE may determine to solicit feedback. If not, (e.g., if the remaining time is less than or equal to the amount of time to perform the threshold number of transmissions with feedback) the UE may determine to perform blind retransmissions, e.g., without soliciting feedback.

For example, the UE may compare any transmission time requirement to the amount of time to perform one or more retransmissions with and/or without soliciting feedback. For example, for data with certain QoS requirements (e.g., stringent transmission time such as latency of 10 ms, etc.), the UE may determine not to solicit feedback (e.g., not to rely on HARQ feedback to perform retransmissions). For example, stringent latency requirements may impair the UE's ability to achieve a reliability requirement (e.g., by performing a number of retransmissions expected to fulfil the reliability requirement) if feedback is solicited. Thus, the UE may not solicit feedback and may instead select a number of blind retransmissions may be used in this case, e.g., the number of transmissions expected to meet the reliability requirement. Alternatively, and/or additionally, the UE may select a number of blind retransmissions based on a maximum number of blind retransmissions (e.g., N). For example, the number of blind transmissions selected may not exceed a configured maximum. Similarly, the UE may reserve resources to perform the maximum number of blind retransmissions. To reserve the resources to perform blind retransmissions, the UE may reserve resources for transmitting the desired (e.g., maximum or smaller) number of retransmissions without allowing time in between retransmissions for receiving or processing feedback. In other words, the reservation may be for the time necessary to transmit each respective transmission consecutively, e.g., without time for receiving feedback for one retransmission prior to transmitting a next retransmission.

In some embodiments, the UE may determine to solicit feedback for one or more transmissions and also determine to perform a number of blind retransmissions. In the event that positive acknowledgement (e.g., from all UEs of the group that are intended recipients of the transmission) is received for at least one of the one or more transmissions, the blind retransmissions may be stopped (e.g., before all of the number of blind retransmissions are performed).

As another example, the UE may determine not to solicit HARQ feedback-based on a comparison of the latency associated with HARQ feedback (e.g., considering the configuration of the PSFCH resources, e.g., every 1, 2, or 4 slots, etc.) to the timing requirements. For example, if the latency associated with HARQ feedback does not allow for a threshold (e.g., minimum) number of retransmissions within the timing requirements, blind retransmission may be used.

As a second possibility, the UE may consider a remaining number of available (re)transmissions. If the transmission is the last transmission in a configured maximum number of transmissions (e.g., the remaining number of available (re)transmissions is 1), the UE may determine not to solicit feedback.

In some embodiments, the UE may compare the number of remaining available (re)transmissions to the number of retransmissions expected to meet the reliability target (e.g., or other threshold number of retransmissions). For example, if the remaining number of retransmissions is less than or equal to the threshold number of transmissions, the UE may perform blind retransmissions.

In some embodiments, the threshold number of retransmissions and/or number of blind retransmissions to perform may be based on a reliability requirement, number of previous transmissions, and/or channel conditions, according to some embodiments. For example, if a reliability requirement is high (e.g., an error rate of a QoS of the transmission is low), the threshold number and/or number of blind retransmissions may be relatively high. Similarly, if a number of previous retransmissions for which negative feedback (NACK) has been received is high, the threshold number and/or number of blind retransmissions may be relatively high. Similarly, if channel conditions (e.g., signal to noise ratio, etc.) are poor, the threshold number and/or number of blind retransmissions may be relatively high.

As a third possibility, the UE may consider whether any resources provided by the BS (e.g., in control information) allow time for feedback. For example, the UE may consider if time gaps between transmission times allow for receiving and processing feedback. Similarly, the UE may consider whether gaps are provided. Thus, if no gaps (or insufficient gaps) are provided, the UE may determine to perform blind (re)transmission, e.g., for resources that do not include sufficient gaps. Note that this resource analysis may include a determination to perform some transmissions with feedback (e.g., at times where sufficient gaps are present) and to perform some transmissions without feedback (e.g., at times without sufficient gaps).

As a fourth possibility, the UE may consider whether any resources provided by the BS (e.g., in control information) allow for the UE to request resources for further retransmissions. For example, if the control information includes an uplink grant (e.g., at an appropriate time), the UL may determine that uplink resources are available. The UE may use such uplink resources to solicit further SL resources for further retransmissions, e.g., by forwarding negative feedback to the BS if negative feedback is received from a peer UE. Similarly, if the resources provided in control information do not include appropriate uplink resources, the UE may recognize that soliciting additional SL resources for further retransmission in the time available (e.g., within transmission time requirements) is not feasible. The UE may determine to perform blind retransmission.

In some embodiments, for a flexible feedback scheme, in determining whether to solicit feedback for the transmission, the UE may consider a configured maximum number of blind retransmissions (e.g., N, where N may be configured in control information as discussed in 902). The UE may consider the maximum number of blind retransmissions in comparison to a maximum number of total retransmissions. In other words, the UE may reserve blindly for a limited number of retransmissions (e.g., only the last N retransmissions). In some embodiments, the UE may make reservations (e.g., for blind retransmissions) flexibly (e.g., without a network-configured limit on the number of retransmissions, N).

In some embodiments, for a flexible feedback scheme, the UE may (e.g., further) consider channel conditions, such as congestion level, in determining whether to solicit feedback for the transmission. For example, if the congestion level (e.g., evaluated CR) is high or above a threshold, then feedback may be solicited (e.g., blind retransmission may not be triggered). This may potentially reduce the total number of retransmissions of the transmission, and thus may limit the contribution of the transmission and retransmissions to channel occupancy. If the evaluated CR is low, then blind retransmission may be triggered (e.g., feedback may not be solicited). As discussed above, this may allow for more retransmissions within time constraints (e.g., PDB).

In some embodiments, some LCH, SLRBs, or flows may be associated with a non-flexible resource scheme (e.g., indicating that HARQ feedback is disabled and that blind transmissions should be used), however some aspects of flexible feedback scheme may be applied to such transmissions, e.g., after those LCHs are multiplexed in a TB. For example, if a transmission of a LCH configured with “HARQ feedback disabled” is selected in a TX pool with PSFCH resource configured, the UE may selectively determine to enable feedback. In other words, the UE may make an adaption and enable feedback for a transmission and/or one or more retransmissions (e.g., blind or feedback-based). For example, the UE may enable feedback for this transmission if the channel is busy (e.g., CBR and/or CR is high). This may potentially increase the reliability. Further, the PSFCH resources may be available (e.g., considered free to use). Then, the UE may (e.g., at a MAC layer) cancel the blind retransmission(s) if positive feedback (e.g., an ACK from each peer device in the group/region) is received. If negative feedback (NACK) is received (e.g., or if positive feedback is not received from all expected peer devices), the UE may not cancel the blind retransmission(s) and may continue to perform the blind transmissions until positive feedback is received or a planned number of blind retransmissions is completed. The total number of (re)transmissions may be bound by a condition-specific (e.g., CBR-adapted) maximum number of (re)transmissions. Thus, this approach may reduce the usage of channel resources, while still maintaining the desired level of reliability.

In some embodiments, a determination to not solicit feedback may result in the UE avoiding the need to request additional resources (e.g., for feedback-based retransmission). For example, a mode 1 TX UE may not share feedback with a BS to solicit retransmission resource. Instead, the UE may (e.g., based on determining not to solicit feedback for a transmission) acquire resources (e.g., by contention or scheduling request, etc.) acquire resources for the transmission and in planned retransmissions. Such an acquisition of resources may be performed all at once, according to some embodiments.

The UE 106 may transmit the transmission (908), according to some embodiments. The UE 106 may also transmit an indication of whether feedback is solicited, according to some embodiments. The indication may be transmitted concurrently with (e.g., potentially as part of) the transmission and/or the indication may be transmitted separately. The UE may also transmit any number of (e.g., blind) retransmissions, e.g., as determined in 906 or as otherwise determined. The UE may also transmit indication(s) of whether feedback is requested for any retransmissions. One indication may be used to indicate whether or not feedback is requested for a single (re)transmission and/or multiple (re)transmissions.

The UE may use layer 1 (L1) signaling to indicate whether or not feedback is solicited, according to some embodiments. The L1 signaling may use SCI format A or B, among various possibilities. Any format may be used to indicate that feedback is or is not solicited.

For SCI format A, if a TX UE determines not to request feedback (e.g., to suppress the PSFCH transmission of any receiving (RX) UE), it may indicate the request using a location parameter or other parameter in the SCI format A. For example, the TX UE may include a “0” in the range parameter. Similarly, a zone ID value may be specified to indicate that feedback is not requested. Further, a different parameter of the SCI format A may be used (or a new parameter may be added) to indicate that feedback is not requested for a transmission. Thus, any RX UEs detecting the indication that feedback is not requested may determine not to transmit ACK/NACK feedback. The RX UEs may decode the transmission.

In some embodiments, a network may configure (e.g., and/or or a wireless communication standard may specify) UEs to decode messages with a range parameter equal to 0. In other words, layer 2 (L2) signaling may be used to configure UEs to correctly interpret the layer 1 indication. For example, RRC configuration may be modified to allow “range=0” to be added as a code point and/or to indicate that messages with range=0 should be decoded.

SCI format B may include a field to indicate “no feedback”. Thus, a TX UE may use this field to indicate whether or not feedback is requested.

Thus, either SCI format A or B may be used to indicate whether feedback is (or is not) requested. Other formats may also (or alternatively) be used, according to some embodiments.

In some embodiments, a same SCI format may be used for retransmissions as for a first transmission. For example, if SCI format A is used for a first transmission (e.g., of a TB, etc.), SCI format A may also be used for any retransmission(s) of the transmission (e.g., of the TB). In other words, a UE may continue using the same SCI format for any retransmissions of a transmission. In some embodiments, a UE may switch to a different format.

In some embodiments, the UE 106 may receive feedback (e.g., ACK and/or NACK, e.g., on PSFCH) from one or more peer UEs (e.g., members of the group for which the transmission is intended).

If the feedback (and/or lack of feedback) indicates that all or a group of peer UEs successfully received the transmission (e.g., positive feedback and/or absence of negative feedback, such as in a NACK-only scheme), the UE may cease further retransmissions of the transmission. For example, the UE may determine based on receiving enough ACKs and/or receiving no NACKs that the peer UEs received the transmission and may stop any remaining retransmissions. In some embodiments, the UE may continue retransmissions.

If the feedback is negative (e.g., at least one peer UE did not successfully receive the transmission, e.g., which may be indicated by a NACK or absence of an ACK), the UE may determine to transmit one or more (e.g., additional) retransmissions and/or to continue with planned retransmissions.

### Additional Information and Examples

In one example, a UE may transmit a transmission and determine (e.g., based on criteria such as remaining time associated with the transmission in comparison to the amount of time needed to receive feedback and transmit a number of retransmissions; maximum number of blind retransmissions; maximum number of total transmissions; etc.) to solicit feedback for it. The UE may receive negative feedback, e.g., at least one NACK. In response to the negative feedback, the UE may determine to retransmit the transmission. The UE may further determine whether to solicit feedback for a next (re)transmission (e.g., based on similar criteria and updated information). The UE may repeat this process of receiving (e.g., negative) feedback and determining to retransmit (e.g., and solicit feedback) any number of times. The UE may determine not to solicit feedback for further retransmissions if the remaining time associated with the transmission does not allow for sufficient retransmissions with feedback to reach a minimum number of total transmissions (e.g., the minimum number based on a reliability standard). Thus, the UE may reserve resources for a number of (e.g., consecutive) retransmissions to reach the minimum number of total transmissions. In some embodiments, the UE may solicit feedback for one or more of the retransmissions (e.g., even without allowing time to receive and/or process the feedback prior to transmitting a next retransmission). The UE may then cease further retransmissions after processing the feedback, if the feedback is positive (e.g., or no negative feedback was received in a NACK-only scheme).

In some embodiments, a UE may use feedback-based transmissions for a first number of retransmissions and may use consecutive (e.g., blind, non-feedback-based) retransmissions for a remaining number of retransmissions. The UE may switch from feedback-based to consecutive retransmissions when the UE is approaching a limit (e.g., transmission time requirement and/or maximum retry limit). For example, a UE may not request feedback for a last transmission within a retry limit.

In one set of embodiments, per each transmission attempt of a packet, a UE may indicate to the peer UE(s) to solicit HARQ feedback or not. The indication of whether feedback is solicited may or may not be the same as the last attempt or any other previous attempt.

In some embodiments, the UE may indicate “no feedback” if the transmission will be the last transmission according to a configured maximum number of (re)transmissions.

In some embodiments, the UE may indicate “no feedback” if the transmission is the last one allowed before the packet delay budget is met.

In another set of embodiments, a system may be configured to allow flexible mixing of blind retry and feedback-based retry.

In another set of embodiments, a UE may be configured with an upper bound of retransmissions which may be conducted blindly.

In some embodiments, when the UE is configured to allow blind retransmission, the UE may reserve the resource for blind retransmission when the time gap requirements for a resource selection may not be possible.

In some embodiments, when the UE is configured to allow blind retransmission, the UE may only apply blind retransmission to a last few retransmissions attempts which may be available before UE hits the packet delay budget or max transmission limit.

In some embodiments, configuration may be performed by: standards specification (e.g., flexible feedback and/or blind retransmission may always allowed), NW configuration, or pre-configuration in RRC protocol. The configuration may be on a per-UE, per-pool, per-flow/SLRB, per-CR/CBR basis.

In some embodiments, a user equipment device (UE), may comprise a radio; and a processor operably connected to the radio and configured to cause the UE to: receive configuration information from a base station, the configuration information including a maximum number of blind retransmissions; generate a first groupcast transmission; determine to solicit feedback for the first groupcast transmission; transmit the first groupcast transmission and an indication that feedback is solicited for the first groupcast transmission; reserve resources to transmit a number of retransmissions of the first groupcast transmission, wherein the number of the retransmissions is less than or equal to the maximum number of blind retransmissions; and transmit at least one of the number of retransmissions.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station, according to some embodiments.

In some embodiments, a non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus for managing a user equipment device (UE), the apparatus comprising:
a processor configured to cause the UE to:
generate a first transmission, wherein the first transmission is a groupcast or unicast transmission;
determine at least one of:
a remaining number of available retransmissions associated with the first transmission; or
a remaining time associated with the first transmission;
determine whether to solicit feedback for the first transmission based on the remaining number and/or the remaining time; and
transmit the first transmission and an indication of whether feedback is solicited for the first transmission.

2. The apparatus of claim 1, wherein the remaining number of available transmissions is based on a configured maximum number of transmissions, wherein the processor is configured to determine not to solicit feedback for the first transmission when the remaining number of available retransmissions is one.

3. The apparatus of claim 1, wherein the processor is further configured to cause the UE to determine a threshold number of retransmissions, wherein the determination of whether feedback is solicited for the first transmission is based on the threshold number of retransmissions.

4. The apparatus of claim 3, wherein the threshold number of retransmissions is based on a number of retransmissions expected to comply with a reliability target.

5. The apparatus of claim 3, wherein the processor is further configured to cause the UE to:
determine an amount of time to perform the threshold number of retransmissions with feedback enabled; and
compare the amount of time to perform the threshold number of retransmissions with feedback enabled to the remaining time associated with the first transmission, wherein the determination of whether feedback is solicited for the first transmission is further based on the comparison.

6. The apparatus of claim 5, wherein to determine the amount of time to perform the threshold number of retransmissions with feedback enabled is based on feedback scheduling information and a minimum time gap between transmissions.

7. The apparatus of claim 5, wherein the processor is further configured to cause the UE to determine to solicit feedback in response to a determination that the amount of time to perform the threshold number of retransmissions with feedback enabled is less than or equal to the remaining time associated with the first transmission.

8. The apparatus of claim 5, wherein the processor is further configured to cause the UE to determine not to solicit feedback in response to a determination that the amount of time to perform the threshold number of retransmissions with feedback enabled is greater than the remaining time associated with the first transmission.

9. The apparatus of claim 8, wherein the processor is further configured to cause the UE to perform a number of blind retransmissions of the first transmission based on the threshold number of retransmissions.

10. A user equipment device (UE), comprising:
a radio; and
a processor operably connected to the radio and configured to cause the UE to:
receive control information from a base station for a first transmission and retransmissions of the first transmission associated with a hybrid automatic repeat request (HARQ) process;
generate the first transmission, wherein the first transmission is a groupcast or unicast transmission;
determine to solicit feedback for the first transmission based on the control information;
transmit the first transmission and an indication that feedback is solicited for the first transmission;
reserve resources to transmit a plurality of blind retransmissions of the first transmission; and
transmit at least one blind retransmission of the plurality of blind retransmissions.

11. The UE of claim 10, wherein the control information includes:
an indication that flexible feedback is enabled for the first transmission and retransmissions of the first transmission; and
a configuration of blind retransmissions.

12. The UE of claim 11, wherein the configuration of blind retransmissions is specific to the UE.

13. The UE of claim 11, wherein the configuration of blind retransmissions is specific to a sidelink resource pool.

14. The UE of claim 11, wherein the configuration of blind retransmissions is a function of channel congestion.

15. The UE of claim 10, wherein the control information indicates that UE is allowed to do HARQ-enabled retransmission for a transmission marked for blind retransmission.

16. The UE of claim 10, wherein said reserving resources to transmit the plurality of blind retransmissions is in response to determining at least one of:
that time gaps of resources provided in the control information are insufficient for the UE to receive and process feedback for the first transmission; or
that the resources provided in the control information do not include uplink resource for the UE to solicit sidelink resource for further retransmission.

17. The UE of claim 10, wherein the processor is further configured to cause the UE to:
receive first negative feedback indicating that the first transmission was not received by a peer UE, wherein to reserve resources for the plurality of retransmissions is in response to the first negative feedback;
transmit an indication that feedback is solicited for the at least one blind retransmission;
determine that the peer UE successfully received the at least one blind retransmission; and
determine not to transmit a further blind retransmission of the plurality of blind retransmissions.

18. An apparatus for managing a user equipment device (UE), the apparatus comprising:
a processor configured to cause the UE to:
receive a groupcast transmission from a second UE, wherein the groupcast transmission is associated with a location-based parameter; and
based on the location-based parameter:
decode the groupcast transmission; and
determine not to provide feedback in response to the groupcast transmission.

19. The apparatus of claim 18, wherein the location-based parameter indicates a range of 0.

20. The apparatus of claim 19, wherein the processor is further configured to cause the UE to:
receive a second groupcast transmission from the second UE, wherein the second groupcast transmission is associated with a second location-based parameter, wherein the second location-based parameter indicates a second range greater than 0;
determine a range to the second UE;
determine that the range to the second UE is greater than the second range; and
based on the determination that the range to the second UE is greater than the second range, determine not to decode the second groupcast transmission.
